(19) United States
(12) Patent Application Publication
(10) Pub. No.: US 2026/0364705 A1
(43) Pub. Date: Nov. 19, 2026

(54) WELDING TORCH AND ROTATION RETAINING RING

(71) Applicant: Kabushiki Kaisha Kobe Seiko Sho (Kobe Steel, Ltd.), Kobe-shi (JP)

(72) Inventors: Jinjiang WANG, Fujisawa-shi (JP); Tetsuya NAKAO, Fujisawa-shi (JP)

(73) Assignee: Kabushiki Kaisha Kobe Seiko Sho (Kobe Steel, Ltd.), Kobe-shi (JP)

(21) Appl. No.: 19/129,909

(22) PCT Filed: Nov. 16, 2023
(86) PCT No.: PCT/JP2023/041369

§ 371 Date: May 14, 2025

(30) Foreign Application Priority Data
Dec. 23, 2022 (JP) 2022-207021

(51) Int. Cl. B23K 9/16; B23K 9/28

(52) U.S. Cl. CPC B23K 9/164; B23K 9/285

(57) ABSTRACT

This welding torch comprises: a torch barrel portion having a tip end side to which a tip member is attached; a cylindrical attachment body which is inserted onto the torch barrel portion, movement of the attachment body in an axial direction toward the tip end side being restricted by a restricting portion provided on the torch barrel portion; an outer cylindrical body which is fastened to the attachment body on a portion closer to the tip end side, in the axial direction, than the restricting portion such that, in a state in which the outer cylindrical body is externally mounted on the torch barrel portion, movement thereof in the axial direction is restricted; and a retaining ring which is inserted onto the torch barrel portion to restrict rotation of the outer cylindrical body relative to the torch barrel portion.

### TECHNICAL FIELD

The present invention relates to a welding torch, and a rotation retaining ring used in the welding torch and configured to restrict rotation of an outer jacket relative to a torch body.

### BACKGROUND ART

Typically, a welding torch used for arc welding includes a torch body, a tip body, a jacket outer cylinder, an insulating sleeve, an orifice member, a power feed tip, and a nozzle. Of these components, the nozzle is used for the purpose of spraying a shielding gas containing, for example, an inert gas or carbon dioxide onto a welding area, and is attached to the distal end of a welding torch. Because of the position at which the nozzle is attached, the tip of the nozzle is very close to the welding area, so that spatters generated during arc welding adhere to the nozzle tip. When spatters adhere to the nozzle tip, a shielding gas port is clogged by the spatters and this results in a shielding gas failure. A traditional solution to this problem has been to automatically or manually replace the nozzle on a regular basis.

Patent Literature 1 describes a welding torch in which a nut member is provided to restrict the movement of a torch body toward an axially distal side at a predetermined position, and a nozzle is removably attached to a distal side of the nut member, so that the nozzle can be attached without requiring an external thread on an outer periphery of a distal end of the torch body.

### CITATION LIST

### Patent Literature

PTL 1: Japanese Unexamined Patent Application Publication No. 2022-172566

### SUMMARY OF INVENTION

### Technical Problem

In the welding torch described in Patent Literature 1, the nozzle rotates with the nut member about the torch body. As a result, it takes time and effort for the operator to separate each component of the welding torch for maintenance on the welding torch, or to automatically or manually remove the nozzle. If the nozzle rotates with the nut member about the torch body particularly in automatic attachment or detachment of the nozzle, the attachment or detachment operation may fail and take more time than manual removal of the nozzle.

The present invention has been made in view of the circumstances described above. An object of the present invention is to provide a welding torch and a rotation retaining ring that can restrict, with a simple configuration, an outer jacket that supports a nozzle attached to a torch body from rotating about the torch body.

### Solution to Problem

The object of the present invention is achieved by the configuration described below.
(1) A welding torch includes a torch body to which a tip member is attached on a distal side; a cylindrical attaching body slid onto the torch body and restricted by a restricting unit on the torch body from axially moving toward the distal side; an outer jacket fastened to the attaching body on an axially distal side of the restricting unit and restricted from axially moving while being externally mounted on the torch body; and a rotation retaining ring slid onto the torch body to restrict rotation of the outer jacket with respect to the torch body.
(2) In the welding torch according to (1), an inner periphery of the rotation retaining ring has a restricting surface that contacts an across flat formed on an outer periphery of the torch body; and an outer periphery of the rotation retaining ring has a locking projection that is secured in a locking notch cut out in the outer jacket.
(3) In the welding torch according to (2), the locking notch is a recessed portion formed by partially circumferentially cutting a proximal portion of the outer jacket; and the locking projection is a raised portion placed in the recessed portion.
(4) The welding torch according to (1) further includes a tubular member made of an insulating material and providing insulation between the torch body and the outer jacket by being removably externally mounted on the torch body. The tubular member has a coolant supply hole and a coolant return hole radially drilled and arranged at axially and circumferentially different positions. An outer side of the tubular member and an inner side of the outer jacket have therebetween a circulation channel configured to guide cooling water supplied from the coolant supply hole to the coolant return hole. The torch body includes an outer pipe, and an inner pipe mounted inside the outer pipe and extending beyond the outer pipe toward the axially distal side. An outer periphery of the inner pipe has a supply channel configured to supply cooling water between the inner pipe and the outer pipe, a supply opening axially extending from the supply channel and opening beyond a position opposite the coolant supply hole on the axially distal side of the outer pipe, a return channel configured to return cooling water between the inner pipe and the outer pipe, and a return opening axially extending from the return channel and opening beyond a position opposite the coolant return hole on the axially distal side of the outer pipe. The supply channel and the supply opening are formed at a circumferentially different position from the return channel and the return opening. The rotation retaining ring has another locking projection secured in another locking notch cut out in the tubular member, and restricts rotation of the tubular member with respect to the torch body.
(5) In the welding torch according to (4), the supply channel and the supply opening and the return channel and the return opening are provided by two flat surfaces formed on the outer periphery of the inner pipe in circumferentially different phases.
(6) In the welding torch according to (4), the another locking projection of the rotation retaining ring is formed by axially protruding an axial side surface of the rotation retaining ring.
(7) A rotation retaining ring is formed as a ring externally mounted on a torch body. An inner periphery of the rotation retaining ring has a restricting surface that contacts an across flat formed on an outer periphery of the torch body; an outer periphery of the rotation retaining ring has a raised portion that is placed in a recessed portion formed at an axial end portion of an outer jacket externally mounted on the torch body; and the rotation retaining ring is configured to restrict rotation of the outer jacket about the torch body.
(8) In the rotation retaining ring according to (7), the raised portion axially protruding is placed in a recessed portion formed at an axial end portion of a tubular member to restrict rotation of the tubular member about the torch body. The tubular member is made of an insulating material and externally mounted on the torch body to provide insulation between the torch body and the outer jacket.

### Advantageous Effects of Invention

In the present invention, where the torch body is provided with the rotation retaining ring having a simple configuration, the outer jacket that supports the nozzle can be restricted from rotating relative to the torch body. This facilitates removal of the nozzle, allows the operator to smoothly and easily perform an attaching operation of attaching the outer jacket to the torch body and a detaching operation of detaching the outer jacket from the torch body, and thus improves the maintainability of the welding torch.

### BRIEF DESCRIPTION OF DRAWINGS

FIG. 1 is a schematic side view of a welding robot that includes a welding torch to which the present invention is applied.

FIG. 2 is a perspective view of the welding torch to which the present invention is applied.

FIG. 3 is a side view of the welding torch to which the present invention is applied.

FIG. 4 is an exploded perspective view of the welding torch to which the present invention is applied.

FIG. 5 is a bottom view of a torch body.

FIG. 6(A) is a perspective view of an insulating sleeve, and FIG. 6(B) is a central cross-sectional view of the insulating sleeve.

FIG. 7 is a cross-sectional view of a main part of the welding torch and illustrates a circulation channel for cooling water.

FIG. 8(A) to FIG. 8 (C) are a perspective view, a front view, and a side view of a rotation retaining ring.

FIG. 9 is a perspective view of a main part and illustrates how the rotation retaining ring is attached.

### DESCRIPTION OF EMBODIMENTS

A configuration of a welding torch to which the present invention is applied will now be described with reference to the accompanying drawings. Each drawing is created for explanation of the present invention and embodiments of the present invention are not limited to those illustrated in the drawings.

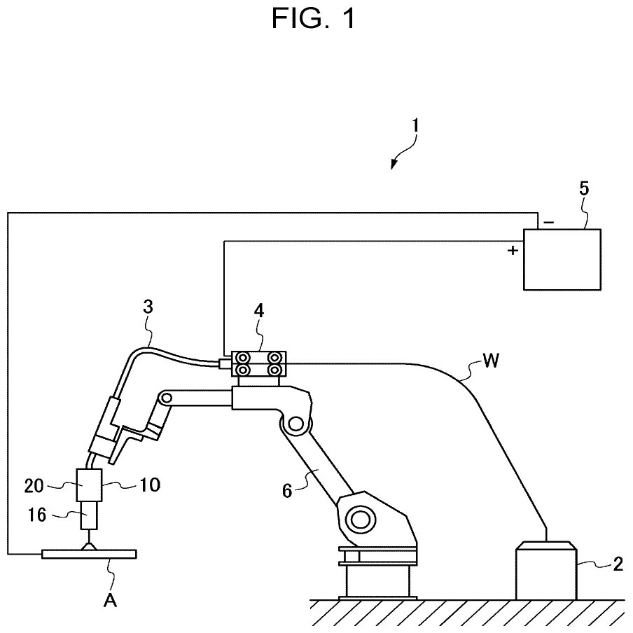

To provide an overview of a welding torch to which the present invention is applied, a welding robot including the welding torch will be described on the basis of FIG. 1. FIG. 1 is a schematic side view of a welding robot that includes a welding torch according to an embodiment.

As illustrated in FIG. 1, a welding robot 1 includes a wire pack 2, a torch cable 3, a wire feeding device 4, a welding power source 5, a manipulator 6, and a welding torch 10. Note that a reference character A in FIG. 1 denotes a welding workpiece to be welded.

The wire pack 2 is, as illustrated in FIG. 1, a supply source of welding wire W and stores a predetermined amount of the welding wire W. The welding wire W may be, for example, a copper-plated wire or a wire not plated with copper.

The torch cable 3 supplies, to the welding torch 10, a welding current supplied from the welding power source 5, the welding wire W stored in the wire pack 2, and shielding gas supplied from a shielding gas storage device (not illustrated). The torch cable 3 is connected at one end thereof to the wire feeding device 4 and connected at the other end thereof to the welding torch 10.

The wire feeding device 4 feeds the welding wire W via the torch cable 3 to the welding torch 10 using, for example, a roller. With the wire feeding device 4, the welding wire W is automatically fed to the welding torch 10.

The welding power source 5 is a supply source of a welding current, and supplies the welding current to the welding torch 10 via the wire feeding device 4 and the torch cable 3.

The manipulator 6 is an articulated robot with the welding torch 10 attached to its distal end. The operation of the manipulator 6 is controlled by a robot control device (not illustrated).

In the following embodiments, the direction in which the welding torch 10 extends will be referred to as an axial direction. The direction in which the welding wire W is fed with respect to the axial direction of the welding torch 10 will be referred to as forward or distal side. The direction opposite the direction in which the welding wire W is fed with respect to the axial direction of the welding torch 10 will be referred to as backward or proximal side.

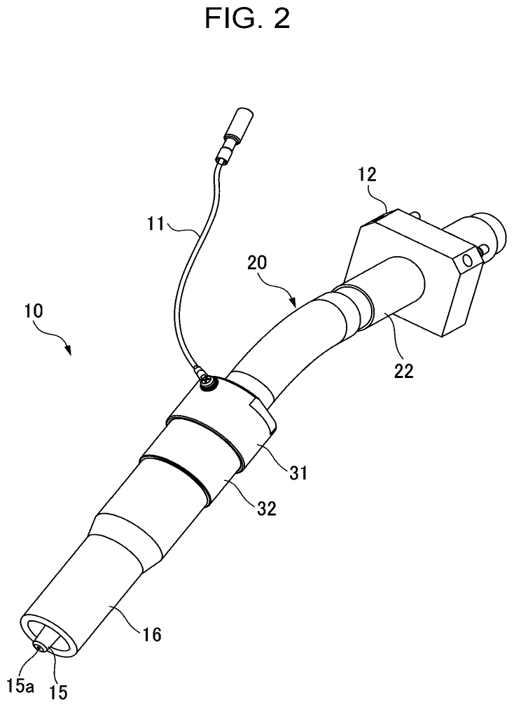

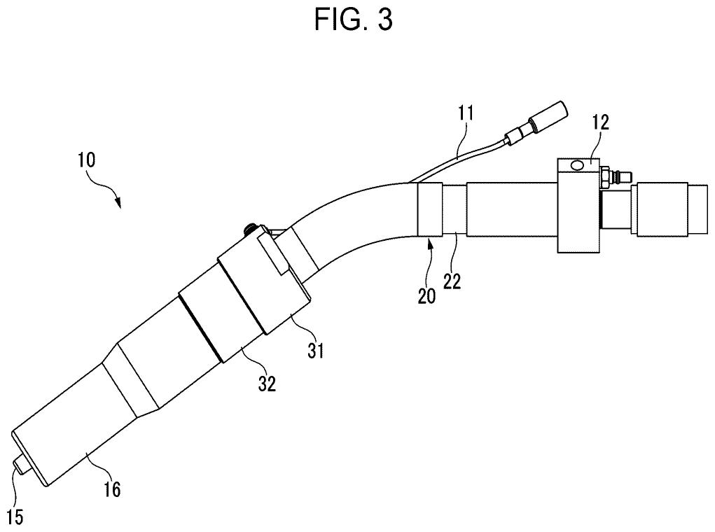

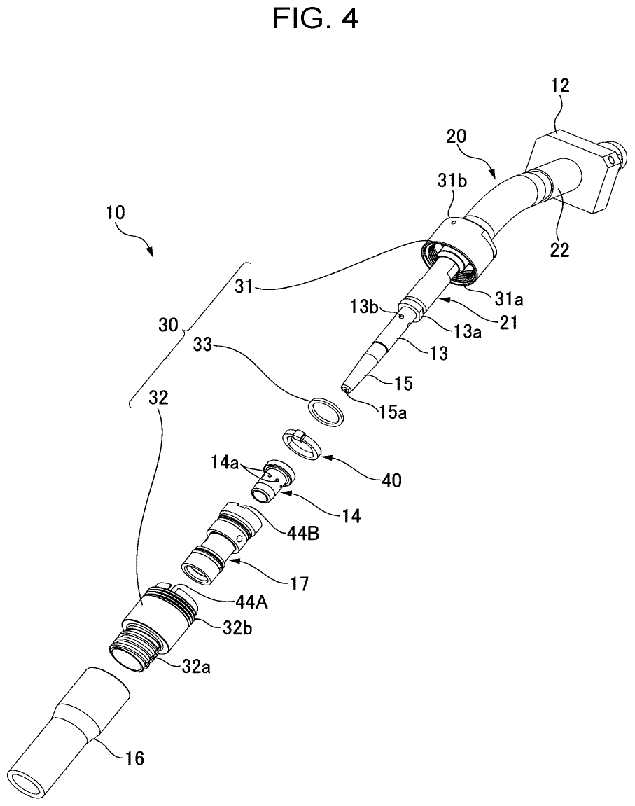

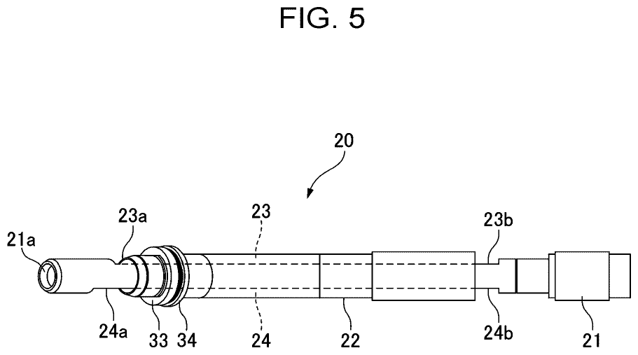

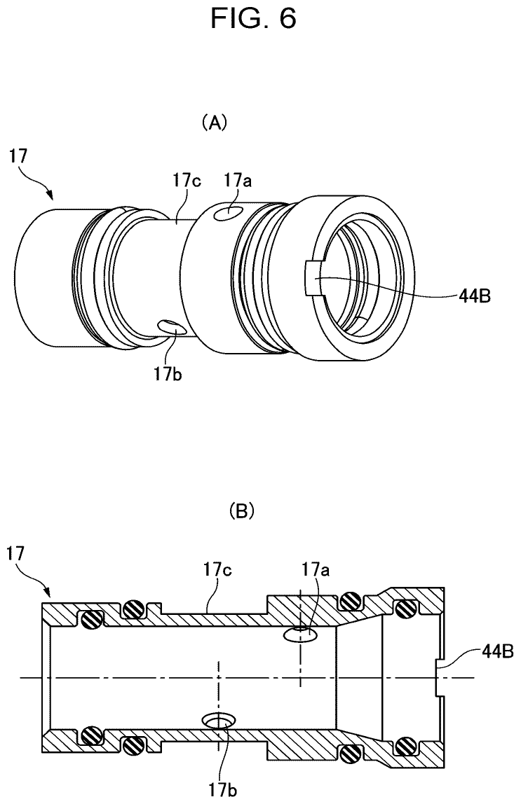

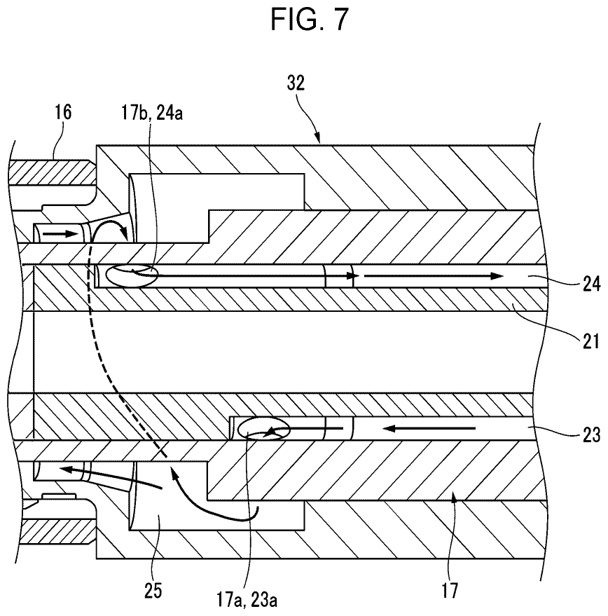

A configuration of the welding torch 10 according to the present embodiment will now be described on the basis of FIG. 2 to FIG. 7. FIG. 2 and FIG. 3 are a perspective view and a side view, respectively, of the welding torch to which the present invention is applied. FIG. 4 is an exploded perspective view of the welding torch to which the present invention is applied. FIG. 5 is a bottom view of a torch body. FIG. 6(A) is a perspective view of an insulating sleeve and FIG. 6(B) is a central cross-sectional view of the insulating sleeve. FIG. 7 is a cross-sectional view of a main part of the welding torch and illustrates a circulation channel for cooling water.

The welding torch 10 is configured to perform arc welding using the welding wire W automatically fed into a cylinder. As illustrated in FIG. 2, a nozzle detection cable 11 and a cooling water supply unit 12 are attached to the welding torch 10.

The nozzle detection cable 11 is for detecting contact between the nozzle 16 and the welding workpiece A by passing a small current through the nozzle. The cooling water supply unit 12 is for circulating and supplying cooling water to the welding torch 10.

### Welding Torch 10

The welding torch 10 includes, as illustrated in FIG. 4, a torch body 20, a tip body 13, a diffuser 14, a contact tip 15, a nozzle 16, an insulating sleeve 17, a nozzle mounting structure 30, and a rotation retaining ring 40.

The nozzle mounting structure 30 includes a nut member 31, an outer jacket 32, and a retaining ring 33. The nozzle 16 is removably attached to the distal side of the torch body 20.

The rotation retaining ring 40 restricts the outer jacket 32 supporting the nozzle 16 and the insulating sleeve 17 from rotating relative to the torch body 20.

### Torch Body 20

The torch body 20 includes an inner pipe 21 having a cylindrical shape, and an outer pipe 22 into which the inner pipe 21 is inserted. With the outer surface of the inner pipe 21 fitted to the inner surface of the outer pipe 22, the inner pipe 21 and the outer pipe 22 are integrated. The inner pipe 21 is formed longer than the outer pipe 22 in such a way as to axially protrude from the front end and the back end of the outer pipe 22.

A conduit tube (not illustrated) configured to guide the welding wire W supplied from the torch cable 3 is inserted in the inner pipe 21. The inner pipe 21 is supported by a torch clamp (not illustrated) on the back side, with the nozzle 16 and the tip body 13 attached to extend from the axially distal side of the inner pipe 21.

As illustrated in FIG. 5, a supply channel 23 for supplying cooling water and a return channel 24 for returning cooling water are formed between the inner pipe 21, the outer pipe 22, and the insulating sleeve 17 by forming a pair of across flats along the longitudinal direction on the outer periphery of the inner pipe 21.

The supply channel 23 and the return channel 24 longitudinally protrude from the front and back ends of the outer pipe 22.

The supply channel 23 and the return channel 24 have, on the axially proximal side thereof, a supply-side connecting portion 23b and a return-side connecting portion 24b, respectively, that are connected to the cooling water supply unit 12. The cooling water supply unit 12 connected to the supply-side connecting portion 23b and the return-side connecting portion 24b supplies cooling water to the supply channel 23 and returns cooling water from the return channel 24.

One of the supply channel 23 and the return channel 24 is longer than the other on the distal side, in the direction of the distal end. In the illustrated example, the return channel 24 is formed longer than the supply channel 23 in the direction of the distal end.

### Tip Body 13

The tip body 13 has a cylindrical shape and has a mechanism that supports the diffuser 14 and the contact tip 15. The tip body 13 is made of a conductive material, such as metal.

The inner surface of the distal end of the tip body 13 has an internal thread (not illustrated) for fastening the contact tip 15.

The outer surface of the back end of the tip body 13 has an external thread (not illustrated) to which the internal thread at the front end of the inner pipe 21 is fastened. The tip body 13 is formed with the inside diameter thereof greater than the outside diameter of the conduit tube, so that a certain space is created between the inner surface of the tip body 13 and the outer surface of the conduit tube.

The diffuser 14 having a cylindrical shape is slid onto the tip body 13 from the distal end. The outer periphery of the tip body 13 has a flange 13a that contacts the diffuser 14 at a predetermined position to restrict the sliding of the diffuser 14. The tip body 13 has a plurality of through-holes 13b, through which the shielding gas circulates, in an area where the diffuser 14 is mounted. The through-holes 13b are equidistantly spaced along the circumferential direction.

### Diffuser 14

The diffuser 14 has a mechanism that rectifies the shielding gas.

The diffuser 14 has a plurality of through-holes 14a, through which the shielding gas circulates, on the distal side of the through-holes in the tip body 13 when the diffuser 14 is mounted on the tip body 13. The through-holes 14a are equidistantly spaced in the circumferential direction. The diffuser 14 can thus smoothly guide the shielding gas flowing into the inner periphery to the through-holes 14a, so that the shielding gas can be prevented from causing turbulence.

### Contact Tip 15

The contact tip 15 has a mechanism that feeds a welding current to the welding wire W and guides the welding wire W to the welding workpiece A to be welded. The contact tip 15 is made of a conductive material, such as metal.

For guiding the welding wire W, the contact tip 15 has an elongated guide hole 15a having an inside diameter slightly greater than the outside diameter of the welding wire W. The guide hole 15a is formed to allow the welding wire W, which is fed from the tip body 13 via the conduit tube, to slide through the internal space while contacting the inner periphery of the guide hole 15a.

### Nozzle 16

The nozzle 16 includes a mechanism that sprays a shielding gas, such as argon or carbon dioxide, supplied from a gas supply device (not illustrated) onto the welding workpiece A to be welded.

The nozzle 16 is formed in a cylindrical shape that can accommodate therein the tip body 13, the diffuser 14, and the contact tip 15 that are in an integrally assembled state.

### Nozzle Mounting Structure 30

The nozzle mounting structure 30 includes the nut member 31 disposed to be slidable along the axial direction of the outer pipe 22, the outer jacket 32 interposed between the nut member 31 and the nozzle 16, and the retaining ring 33 attached to the distal side of the outer pipe 22.

The nut member 31 is a cap nut slid onto the outer pipe 22. The nut member 31 is disposed to be slidable along the outer pipe 22. The nut member 31 thus serves as an attaching body for attaching, to the outer pipe 22, the outer jacket 32 that supports the nozzle 16.

The nut member 31 is in the shape of a cylinder having a bottom and opening at the front. A bottom 31b of the nut member 31 has an insertion hole (not illustrated) that allows insertion of the outer pipe 22. The inner surface of the nut member 31 has an internal thread 31a on the front side for fastening the outer jacket 32.

The retaining ring 33 is a ring-shaped member made of resin. By sliding the retaining ring 33 onto the torch body 20 from the distal side, the retaining ring 33 is attached and secured at a predetermined position on the distal side of the outer pipe 22.

The retaining ring 33 has, on the outer surface of the distal end of the outer pipe 22, a positioning member 34 constituted by an O-ring that fits into a groove (not illustrated). The retaining ring 33 slid onto the outer pipe 22 may be configured such that its axial position is defined by a predetermined position at which it contacts the positioning member 34. This configuration can be seen in FIG. 5.

The outer jacket 32 has a cylindrical shape. As a mechanism that supports the nozzle 16, the outer jacket 32 has, on the outer surface of the distal end thereof, an external thread 32a to which the back end of the nozzle 16 is fastened. The outer jacket 32 has, on the outer surface of the back end thereof, an external thread 32b to which the internal thread 31a of the nut member 31 is fastened.

In the nozzle mounting structure 30 configured as described above, the front surface of the bottom 31b of the nut member 31 contacts the back surface of the retaining ring 33, so that the nut member 31 sliding along the outer pipe 22 is restricted from sliding forward of the retaining ring 33. At the same time, the back part of the outer jacket 32 is fastened to the front part of the nut member 31, so that the nut member 31 is restricted from sliding backward of the retaining ring 33.

That is, the nozzle mounting structure 30 can secure the positions of the outer jacket 32 and the nut member 31 in the axial direction of the torch body 20. This allows the nozzle 16 fastened to the outer jacket 32 to extend on the axially distal side of the torch body 20.

Although the nozzle 16 is configured to be removable from the outer jacket 32 in the example described above, the outer jacket 32 and the nozzle 16 may be integrally molded. In this case, the nozzle 16 is directly removably attached to the nut member 31.

The retaining ring 33 may have any configuration that allows the nut member 31 and the outer jacket 32 to be positioned at predetermined positions on the distal side of the outer pipe 22, and the configuration is not limited to that described above. For example, instead of making the retaining ring 33 separate from the outer pipe 22, a stepped portion for positioning the nut member 31 may be integrally formed on the outer surface of the outer pipe 22.

### Insulating Sleeve 17

The insulating sleeve 17 has the function of preventing electricity passed through the torch body 20 from flowing to the nozzle 16. The insulating sleeve 17 is made of an insulating material, such as synthetic resin. The insulating sleeve 17 is merely an example, and any tubular member made of an insulating material may be used.

The insulating sleeve 17 is a tubular member having a cylindrical shape. The inside diameter of the insulating sleeve 17 is greater than the outside diameter of the inner pipe 21, and the outside diameter of the insulating sleeve 17 is smaller than the inside diameters of the nozzle 16 and the outer jacket 32. The insulating sleeve 17 is fitted and housed in the outer jacket 32, while it fits and houses the front part of the inner pipe 21 exposed in front of the outer pipe 22.

The insulating sleeve 17 has a coolant supply hole 17a and a coolant return hole 17b that are radially drilled and arranged at axially and circumferentially different positions. As illustrated in FIG. 6(A) and FIG. 6(B), the coolant supply hole 17a is disposed on the axially proximal side of the insulating sleeve 17, whereas the coolant return hole 17b is disposed on the axially distal side of the insulating sleeve 17. The insulating sleeve 17 has, in an axially middle section thereof, a circumferential groove 17c that reduces the diameter of the insulating sleeve 17. The coolant return hole 17b is formed to open in the groove 17c.

A distal end portion of the supply channel 23 and a distal end portion of the return channel 24 are formed between the inner surface of the insulating sleeve 17 and a pair of across flats formed on the outer surface of the inner pipe 21. Specifically, the supply channel 23 has, on the axially distal side thereof, a supply opening 23a that opens beyond the position opposite the coolant supply hole 17a, whereas the return channel 24 has, on the axially distal side thereof, a return opening 24a that opens beyond the position opposite the coolant return hole 17b.

In other words, by extending the across flats beyond the outer pipe 22 to the positions opposite the inner surface of the insulating sleeve 17, the supply opening 23a communicating with the coolant supply hole 17a and the return opening 24a communicating with the coolant return hole 17b are formed in the inner pipe 21. This configuration can be seen in FIG. 5 and FIG. 7.

The axial rotation position of the insulating sleeve 17 with respect to the inner pipe 21 is secured at a predetermined position by the rotation retaining ring 40. This allows the coolant supply hole 17a to be positioned opposite the supply channel 23 of the inner pipe 21, and allows the coolant return hole 17b to be positioned opposite the return channel 24 of the inner pipe 21.

A circulation channel 25, which is an annular space, is formed between the outer surface of the insulating sleeve 17 and the inner surface of the outer jacket 32. The circulation channel 25 allows cooling water supplied from the supply opening 23a via the coolant supply hole 17a to return via the coolant return hole 17b to the return opening 24a.

In this configuration, the coolant supply hole 17a and the coolant return hole 17b are arranged at axially and circumferentially different positions. This allows cooling water flowing in the circulation channel 25 to flow not only in the circumferential direction of the outer surface of the inner pipe 21, but also in the axial direction, so that the efficiency of cooling the welding torch 10 with the cooling water is improved.

In the welding torch 10 described above, the welding wire W supplied from the torch cable 3 can be supplied to the guide hole 15a at the distal end of the contact tip 15 via the conduit tube inserted in the tip body 13. Also, in the welding torch 10, a welding current supplied from the welding power source 5 can be supplied to the welding wire W via the torch body 20, the tip body 13, and the contact tip 15. Additionally, in the welding torch 10, shielding gas supplied to the space formed between the inner surface of the tip body 13 and the outer surface of the conduit tube can be supplied from the distal end of the nozzle 16 toward the welding workpiece A via the through-hole 13b in the tip body 13 and the diffuser 14.

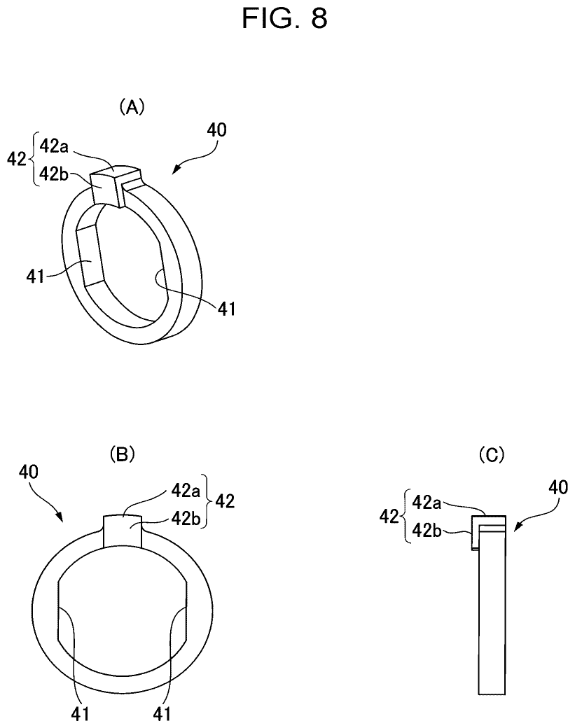

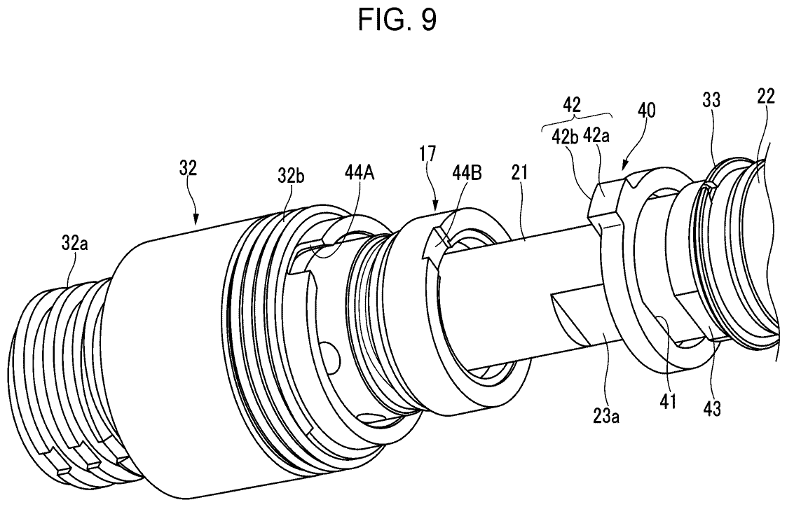

The rotation retaining ring 40 will now be described on the basis of FIG. 4 to FIG. 9. FIG. 8(A) to FIG. 8(C) are a perspective view, a front view, and a side view of the rotation retaining ring. FIG. 9 is a perspective view of a main part and illustrates how the rotation retaining ring is attached.

The rotation retaining ring 40 is an annular member slid onto the torch body 20 and disposed at the distal end of the outer pipe 22. The rotation retaining ring 40 has restricting surfaces 41 and 41, which are a pair of flat surfaces parallel to each other and formed by partially cutting the inner surface of the annular member. The rotation retaining ring 40 has a locking projection 42, which is a raised portion protruding radially outward. This configuration can be seen in FIG. 8(A) to FIG. 8(C).

The restricting surfaces 41 have the function of supporting the rotation retaining ring 40 to the distal side of the outer pipe 22 while restricting rotation about the torch body 20.

The restricting surfaces 41 contact a pair of across flats 43 and 43 formed at predetermined positions on the outer surface of the front part of the outer pipe 22, so that the inner surface of the rotation retaining ring 40 can be fitted and secured at the predetermined positions on the outer surface of the front part of the outer pipe 22. This configuration can be seen in FIG. 9.

The locking projection 42 has the function of restricting the axial rotation of the outer jacket 32 and the insulating sleeve 17 with respect to the rotation retaining ring 40 by being secured in locking notches 44A and 44B, which are recessed portions formed on the proximal side of the outer jacket 32 and the proximal side of the insulating sleeve 17.

The locking projection 42 includes a first locking projection 42a protruding radially outward from the rotation retaining ring 40, and a second locking projection 42b protruding axially forward from the axial side surface of the rotation retaining ring 40. In the illustrated example, a single raised portion protrudes radially outward and forward to serve both as the first locking projection 42a and the second locking projection 42b. The first locking projection 42a and the second locking projection 42b may be constituted by separate raised portions.

The first locking projection 42a can restrict the rotation of the outer jacket 32 about the torch body 20 by being placed in the first locking notch 44A, which is a recessed portion formed by cutting the outer jacket 32 forward from the proximal side. That is, the nozzle 16 attached to the outer jacket 32 can also be restricted from rotating about the torch body 20.

The second locking projection 42b is placed in the second locking notch 44B, which is a recessed portion formed by cutting the insulating sleeve 17 forward from the proximal side. The rotation retaining ring 40 can thus restrict the rotation of the insulating sleeve 17 about the torch body 20.

The rotation retaining ring 40 in the welding torch 10 restricts the axial rotation of the outer jacket 32 with respect to the torch body 20. Therefore, when the nozzle 16 is removed from the welding torch 10, only the nozzle 16 can be easily rotated without causing the outer jacket 32 to rotate with the nozzle 16, so that the nozzle 16 can be smoothly and easily removed from the welding torch 10.

Similarly, when the nozzle 16 is removed from the welding torch 10, only the nut member 31 can be easily rotated without causing the outer jacket 32 to rotate with the nut member 31, so that the outer jacket 32 to which the nozzle 16 is fastened can be smoothly and easily removed from the nut member 31.

The rotation retaining ring 40 in the welding torch 10 restricts the rotation of the insulating sleeve 17 about the torch body 20, so that the coolant supply hole 17a and the coolant return hole 17b can be reliably positioned opposite the supply opening 23a and the return opening 24a, respectively. In other words, the coolant supply hole 17a and the supply opening 23a can be axially shifted and arranged in a circumferentially different phase from the coolant return hole 17b and the return opening 24a.

The present invention is not limited to the embodiments described above, and any combinations of configurations of the embodiments, as well as any changes or applications made by those skilled in the art on the basis of the description of the specification and known techniques, are also contemplated by the present invention and are included in the scope of protection sought.

The present specification discloses the following.
(1) A welding torch includes a torch body to which a tip member is attached on a distal side; a cylindrical attaching body slid onto the torch body and restricted by a restricting unit on the torch body from axially moving toward the distal side; an outer jacket fastened to the attaching body on an axially distal side of the restricting unit and restricted from axially moving while being externally mounted on the torch body; and a rotation retaining ring slid onto the torch body to restrict rotation of the outer jacket with respect to the torch body.

With this configuration, the rotation retaining ring restricts the outer jacket supporting the nozzle from rotating with the torch body. This facilitates removal of the nozzle, allows the operator to smoothly and easily perform an attaching operation of axially rotating the attaching body to fasten the outer jacket and a detaching operation of releasing the fastening by using a tool, such as a wrench, and thus improves the maintainability of the welding torch.
(2) In the welding torch according to (1), an inner periphery of the rotation retaining ring has a restricting surface that contacts an across flat formed on an outer periphery of the torch body; and an outer periphery of the rotation retaining ring has a locking projection that is secured in a locking notch cut out in the outer jacket.

With this simple configuration that reduces the number of components and the cost of manufacture, the attaching body and the outer jacket can be restricted from rotating together about the torch body.
(3) In the welding torch according to (2), the locking notch is a recessed portion formed by partially circumferentially cutting a proximal portion of the outer jacket; and the locking projection is a raised portion placed in the recessed portion.

This configuration can minimize the machining of the outer jacket and thus can keep the cost lower.
(4) The welding torch according to any one of (1) to (3) further includes a tubular member made of an insulating material and providing insulation between the torch body and the outer jacket by being removably externally mounted on the torch body. The tubular member has a coolant supply hole and a coolant return hole radially drilled and arranged at axially and circumferentially different positions. An outer side of the tubular member and an inner side of the outer jacket have therebetween a circulation channel configured to guide cooling water supplied from the coolant supply hole to the coolant return hole. The torch body includes an outer pipe, and an inner pipe mounted inside the outer pipe and extending beyond the outer pipe toward the axially distal side. An outer periphery of the inner pipe has a supply channel configured to supply cooling water between the inner pipe and the outer pipe, a supply opening axially extending from the supply channel and opening beyond a position opposite the coolant supply hole on the axially distal side of the outer pipe, a return channel configured to return cooling water between the inner pipe and the outer pipe, and a return opening axially extending from the return channel and opening beyond a position opposite the coolant return hole on the axially distal side of the outer pipe. The supply channel and the supply opening are formed at a circumferentially different position from the return channel and the return opening. The rotation retaining ring has another locking projection secured in another locking notch cut out in the tubular member, and restricts rotation of the tubular member with respect to the torch body.

In this configuration, the coolant supply hole and the coolant return hole defining the circulation channel are arranged at axially and circumferentially different positions. This allows efficient flow of cooling water and improves cooling efficiency of the torch body.
(5) In the welding torch according to (4), the supply channel and the supply opening and the return channel and the return opening are provided by two flat surfaces formed on the outer periphery of the inner pipe in circumferentially different phases.

With this configuration, the supply opening and the return opening can be easily formed and this can keep the cost lower.
(6) In the welding torch according to (4), the another locking projection of the rotation retaining ring is formed by axially protruding an axial side surface of the rotation retaining ring.

With this configuration, the insulating sleeve can be secured in place without forming a plurality of raised portions, so that a simple configuration is achieved.
(7) A rotation retaining ring is formed as a ring externally mounted on a torch body. An inner periphery of the rotation retaining ring has a restricting surface that contacts an across flat formed on an outer periphery of the torch body; an outer periphery of the rotation retaining ring has a raised portion that is placed in a recessed portion formed at an axial end portion of an outer jacket externally mounted on the torch body; and the rotation retaining ring is configured to restrict rotation of the outer jacket about the torch body.

With this configuration, the rotation of the outer jacket relative to the torch body can be restricted by the single rotation retaining ring having a simple shape, so that reduced cost and effort can be achieved.
(8) In the rotation retaining ring according to (7), the raised portion axially protruding is placed in a recessed portion formed at an axial end portion of a tubular member to restrict rotation of the tubular member about the torch body. The tubular member is made of an insulating material and externally mounted on the torch body to provide insulation between the torch body and the outer jacket.

With this configuration, the rotation of the outer jacket and the tubular member relative to the torch body can be restricted by the single rotation retaining ring.

Various embodiments have been described with reference to the accompanying drawings, but the present invention is not limited to such examples. It will be apparent that those skilled in the art can conceive various changes or modifications within the scope of the claims, and it will be understood that such changes or modifications also naturally fall within the technical scope of the present invention. The components in the embodiments described above may be combined in any manner without departing from the spirit of the invention.

The present application is based on a Japanese patent application (Japanese Patent Application No. 2022-207021) filed on Dec. 23, 2022, the contents of which are incorporated herein by reference.

### REFERENCE SIGNS LIST

1 welding robot
2 wire pack
3 torch cable
4 wire feeding device
5 welding power source
6 manipulator
10 welding torch
11 nozzle detection cable
12 cooling water supply unit
13 tip body
13a flange
13b through-hole
14 diffuser
14a through-hole
15 contact tip
15a guide hole
16 nozzle
17 insulating sleeve (tubular member)
17a coolant supply hole
17b coolant return hole
17c groove
20 torch body
21 inner pipe
22 outer pipe
23 supply channel
23a supply opening
23b supply-side connecting portion
24 return channel
24a return opening
24b return-side connecting portion
25 circulation channel
30 nozzle mounting structure
31 nut member (attaching body)
31a internal thread
31b bottom
32 outer jacket
32a external thread
32b external thread
33 retaining ring (restricting unit)
40 rotation retaining ring
41 restricting surface
42 locking projection (raised portion)
42a first locking projection
42b second locking projection
43 across flat
44 locking notch (recessed portion)
44A first locking notch
44B second locking notch
A welding workpiece
W welding wire

1. A welding torch comprising:
a torch body to which a tip member is attached on a distal side;
a cylindrical attaching body slid onto the torch body and restricted by a restricting unit on the torch body from axially moving toward the distal side;
an outer jacket fastened to the attaching body on an axially distal side of the restricting unit and restricted from axially moving while being externally mounted on the torch body; and
a rotation retaining ring slid onto the torch body to restrict rotation of the outer jacket with respect to the torch body.

2. The welding torch according to claim 1, wherein an inner periphery of the rotation retaining ring has a restricting surface that contacts an across flat formed on an outer periphery of the torch body; and
an outer periphery of the rotation retaining ring has a locking projection that is secured in a locking notch cut out in the outer jacket.

3. The welding torch according to claim 2, wherein the locking notch is a recessed portion formed by partially circumferentially cutting a proximal portion of the outer jacket; and
the locking projection is a raised portion placed in the recessed portion.

4. The welding torch according to claim 1, further comprising a tubular member made of an insulating material and providing insulation between the torch body and the outer jacket by being removably externally mounted on the torch body,
wherein the tubular member has a coolant supply hole and a coolant return hole radially drilled and arranged at axially and circumferentially different positions;
an outer side of the tubular member and an inner side of the outer jacket have therebetween a circulation channel configured to guide cooling water supplied from the coolant supply hole to the coolant return hole;
the torch body includes an outer barrel cylinder, and an inner pipe mounted inside the outer barrel cylinder and extending beyond the outer barrel cylinder toward the axially distal side;
an outer periphery of the inner pipe has a supply channel configured to supply cooling water between the inner pipe and the outer barrel cylinder, a supply opening axially extending from the supply channel and opening beyond a position opposite the coolant supply hole on the axially distal side of the outer barrel cylinder, a return channel configured to return cooling water between the inner pipe and the outer barrel cylinder, and a return opening axially extending from the return channel and opening beyond a position opposite the coolant return hole on the axially distal side of the outer barrel cylinder;
the supply channel and the supply opening are formed at a circumferentially different position from the return channel and the return opening; and
the rotation retaining ring has another locking projection secured in another locking notch cut out in the tubular member, and restricts rotation of the tubular member with respect to the torch body.

5. The welding torch according to claim 4, wherein the supply channel and the supply opening and the return channel and the return opening are provided by two flat surfaces formed on the outer periphery of the inner pipe in circumferentially different phases.

6. The welding torch according to claim 4, wherein the another locking projection of the rotation retaining ring is formed by axially protruding an axial side surface of the rotation retaining ring.

7. A rotation retaining ring formed as a ring externally mounted on a torch body, wherein
an inner periphery of the rotation retaining ring has a restricting surface that contacts an across flat formed on an outer periphery of the torch body;
an outer periphery of the rotation retaining ring has a raised portion that is placed in a recessed portion formed at an axial end portion of an outer jacket externally mounted on the torch body; and
the rotation retaining ring is configured to restrict rotation of the outer jacket about the torch body.

8. The rotation retaining ring according to claim 7, wherein the raised portion axially protruding is placed in a recessed portion formed at an axial end portion of a tubular member to restrict rotation of the tubular member about the torch body, the tubular member being made of an insulating material and externally mounted on the torch body to provide insulation between the torch body and the outer jacket.
